(19) United States
(12) Patent Application Publication
(10) Pub. No.: US 2007/0226169 A1
(43) Pub. Date: Sep. 27, 2007

(54) SMART SHARE TECHNOLOGIES FOR AUTOMATICALLY PROCESSING DIGITAL INFORMATION

(75) Inventors: Sergey Solyanik, Seattle, WA (US); Lee C. Linden, Bellevue, WA (US); James C. Gray, Bellevue, WA (US); Todd R. Headrick, Kirkland, WA (US); Charles E. Kindel JR., Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/277,331

(22) Filed: Mar. 23, 2006

(51) Int. Cl. G06F 17/30

(52) U.S. Cl. 707/1

(57) ABSTRACT

A computing system comprising a smart share, a smart share processor coupled to the smart share, a rule accessible to the smart share processor, wherein a file being added to or modified on the smart share results in an event, the event being detected by the smart share processor that determines if the rule applies to the file and, if so, causes the rule to be applied.

### TECHNICAL FIELD

This description relates generally to technologies for processing files and more specifically to automatically processing files and digital content when stored or modified on server shares.

### BACKGROUND

With the current proliferation of computing technology and devices such as portable music and video players, the task of converting and maintaining digital information to formats compatible with these devices is becoming more and more daunting.

Users of digital information, including digital media content such as audio and video, typically prefer to maintain files of such content in an archival-quality format—an encoding which is lossless or near-lossless. For digital audio content this encoding may be such as used for compact disk (“CD”) or digital video disk (“DVD”) audio. For digital video content this encoding may be such as high definition (“HD”) or the DVD-quality Moving Pictures Experts Group 2 (“MPEG2”) standard, as well as other similar quality formats such as Digital Video Express (“DivX”) and Windows Media formats. Such archival-quality formats tend to result in very large files, a consequence of the lossless or near-lossless encoding format.

However, most of these lossless or near-lossless encodings are unsuitable for portable media devices which tend to have limited storage capacity. As a result, typical portable media devices and the like are designed to support digital information in other more compact encoding formats. Such native formats may differ from device to device and may be incompatible with other devices as well as archival-quality formats. Thus, to make use of typical lossless or near-lossless digital information, a “synchronization” step is typically required when copying digital information to such a device. During synchronization, the digital information is typically converted or “transcoded” from its current format to an encoding format compatible with the device. In some cases, particularly with video content, this may take an extended period of time. For example, a 2 hour digital movie may require a full 2 hours to transcode. And, depending on the different types of devices the digital information is to be used with, such transcoding may need to be done for each different encoding format required by the various devices. Managing such a process and the resulting proliferation of files can be both time-consuming and complex.

Further, users of digital information such as digital images or pictures, which are common since the proliferation of digital cameras, also typically prefer to create and maintain such images in a high-resolution format. The typical digital camera also saves “metadata” with a digital image—data or information about the image. Such metadata is commonly used to later identify the picture, when and where it was taken, and to “tag” it with appropriate keywords recognizable to the user, etc. Such digital images are often “published” in “digital photo albums” accessible over the World Wide Web (“WEB” or “Internet”) or other networks.

An example of a popular metadata format for digital images is the Exchangeable Image File (“EXIF”) format, a standard typically used by manufacturers of digital cameras. EXIF is commonly used to associate metadata with a digital image, including information such as the model of the camera used, the date and time the picture was taken, the aperture, exposure time and focal length used in taking the picture, image resolution, etc. Additional metadata can also be added by a user, such as a title, subject, keywords, comments, etc. Users commonly add such additional metadata to aid in identifying and organizing their digital images.

It has become increasingly common for users to publish their digital images on the WEB such that they can be viewed by others. Often the digital pictures are published in digital photo albums via a WEB site that can be accessed by the general public, or that may configured to require a “logon” so as to restrict access to family or friends. Such an album typical provides reduced-resolution “thumbnail” images to make it easy for the viewer to browse the various images and select the ones of interest for full-sized viewing or download. To minimize network bandwidth usage and delay, the images may be published in a reduced-resolution format relative to the original high-resolution format. The process of producing thumbnails and reduced-resolution images, organizing the images in albums, publishing and notifying others of newly published or modified images can be both time-consuming and complex.

Finally, with the advent of the personal video recorder (“PVR”) or digital video recorder (“DVR”), it is increasingly common to digitally record and archive television (“TV”) programs or other video recordings for later viewing. Such recording capability is provided by digital video cameras, pocket TV and video recording devices, set-top boxes such as TiVo, and software digital video recorders and players that operate on personal computers such as Windows Media Center Edition.

Digital TV is typically encoded in MPEG2 format which may be unsuitable for permanent archiving or WEB-based viewing due to the size of the files. For example, a typical one hour show recorded in MPEG2 format requires about 2 gigabytes (“GB”) of storage space. Thus, even the largest disk drive currently available would only store about 100 hours of digitally recorded video. But even with the needed storage space, typical Internet connections make it difficult at best to view such a “real-time” video stream over the WEB due to lack of bandwidth. Transcoding such digital video files into formats more suitable for permanent storage and real-time streaming can be time-consuming and result in a proliferation of files difficult to manage.

### SUMMARY

The following presents a simplified summary of the disclosure in order to provide a basic understanding to the reader. This summary is not an extensive overview of the disclosure and it does not identify all of the key and critical elements of the invention, or delineate the scope of the invention. Its sole purpose is to present some concepts disclosed herein in a simplified form as a prelude to the more detailed description that is presented later.

The present invention provides technologies to automatically process digital information stored in files, the processing automatically initiated by a user simply saving or modifying a file on a “smart share”—a shared folder associated with a “smart share processor” which identifies the digital information type contained in the file and processes it, in part, according to a set of rules associated with various digital information types. Such automatic processing largely eliminates the user burden and complexities otherwise associated with similar manual processes, such as for addressing the complexities and problems described above.

Many of the attendant features of the invention will be more readily appreciated as the same become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram showing a computing environment including a Smart Share Server coupled to other devices via a network.

FIG. 2 is a block diagram showing some of the key elements that make up a smart share server.

FIG. 3 is a block diagram showing the basic process used by a smart share processor to process events, such as creation and modification events related to files in associated smart shares.

FIG. 4 is a block diagram showing an example smart share server configured to process digital image files.

FIG. 5 is a block diagram showing an example rule for processing digital image files.

FIG. 6 is a block diagram showing an example smart share server configured to process digital media files.

FIG. 7 is a block diagram showing an example rule for processing digital media files.

FIG. 8 is a block diagram showing an example computing environment in which the technology described herein may be implemented.

Like reference numerals are used to designate like parts in the accompanying drawings.

### DETAILED DESCRIPTION

The detailed description provided below in connection with the appended drawings is intended as a description of examples of the present invention and is not intended to represent the only forms in which the present invention may be constructed or utilized. The description sets forth functions of the invention and sequences of steps for constructing and operating examples of the invention. However, the same or equivalent functions and sequences may be accomplished by different examples.

Although the present examples are described and illustrated herein as being implemented in a computing environment, the environment described is provided as an example and not a limitation. As those skilled in the art will appreciate, the present examples are suitable for application in a variety of different types of computing environments and systems.

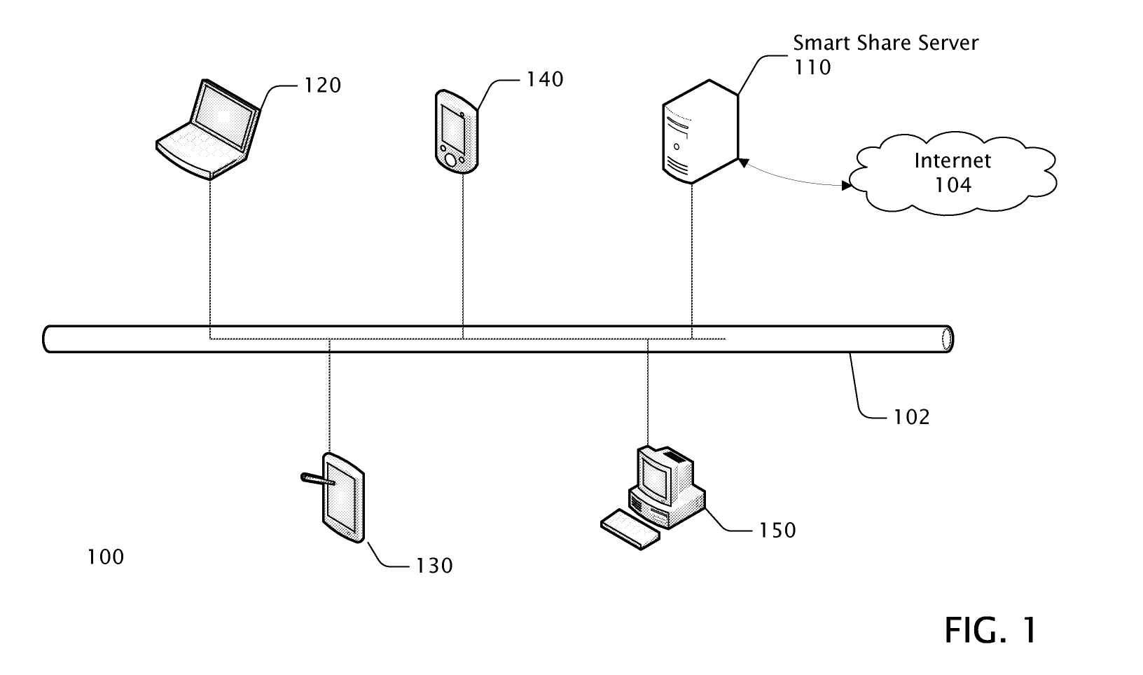

FIG. 1 is a block diagram showing a computing environment 100 including a Smart Share Server (“SSS”) 110 coupled to other devices 120, 130, 140, and 150 via a network 102. SSS 110 is also shown coupled to the Internet 104. In other examples, SSS 110 may not be coupled to the Internet 104. Network 102 may be wired or wireless or a combination of the two. Example forms of wireless device connectivity to network 102 may include radio frequency (“RF”), Infrared (“IR”), BlueTooth, or the like. The forgoing descriptions of network 102 and connectivity to it are provided as examples and not limitations.

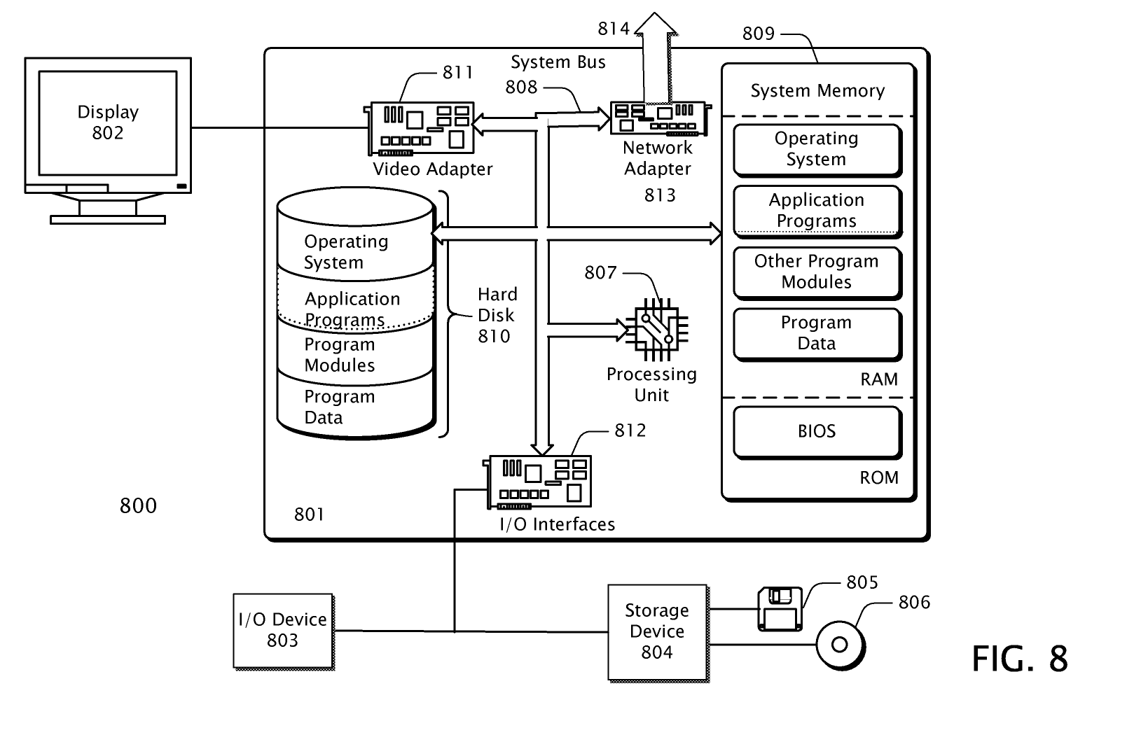

Devices 120, 130, 140, and 150 represent different types of computing systems and electronic devices, such as personal computers (“PCs”) 150, laptop computers 120, hand-held devices 140, tablet PCs 130, etc. These and other devices, such as those described below in connection with FIG. 8, may also work with the present examples. Other examples of applicable devices include digital cameras, digital video cameras, digital music players and recorders, memory card readers, media software operating on a device, and the like.

As used herein, the term “device” refers to any electronic or computing system or the like capable of accessing a shared folder. A shared folder, also known as a network directory, is a folder or directory associated with and available to a particular device and also available to other devices, typically via some type of network connectivity. For example, a shared folder may be a folder or directory located on a PC's local hard drive, the folder having been shared with the other devices, where the PC and other devices can communicate over a common network of some type. The fact that the folder has been made accessible to other devices is what makes it shared. Accessible typically includes, depending on access rights, the ability for the other devices to save files in a shared folder, and access, read, modify and delete files stored in the shared folder.

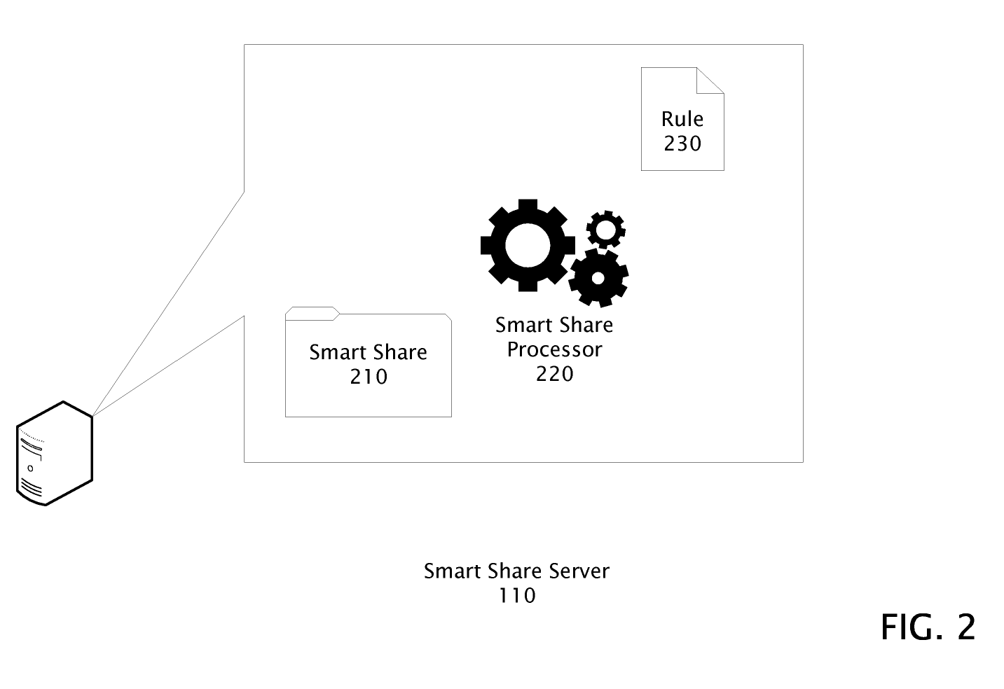

FIG. 2 is a block diagram showing some of the key elements that make up smart share server 110. Smart share 210 is a shared folder associated with smart share processor (“SSP”) 220. Smart share 210 may include any number of shared sub-folders (or sub-directories) also associated with SSP 220. Smart share 210 and any sub-folders may be located on a mass storage device on SSS 110, or may be located on some other remote storage device associated with and coupled to SSS 110. Shared folder 210 and any shared sub-folders may also be distributed across different storage devices associated with and coupled to SSS 110.

SSP 220 is a processing element associated with one or more shared folders, such as smart share 210. In one example these associations are established through configuration settings of SPP 220, which may be pre-configured during the installation of SSP 220 and/or configured or modified by a user. SSP 220 detects events associated with file activity in the associated shared folders. For example, when a file is added to smart share 210, an event of the type “file creation” is generated for that folder, which is detected by SSP 220. Such events are typically generated by the operating system of SSS 110 and may be monitored by software such as SSP 220. Alternatively, when a file already existing on smart share 210 is modified, an event of the type “file modification” is generated. And when a file is deleted, an event of the type “file deleted” is generated. There may be other interesting event types as well and, in some systems, event types may be combined or identified using different terms than these example terms. In other examples, the described events may be provided in the form of call-back functionality, interrupt handlers, procedure calls, or other software and/or hardware mechanisms known to those skilled in the art. For simplicity of discussion, the term “events” will be used with the concept of “deletion” being included in the concept of “modification”.

SSP 220 also has access to one or more rules, such as example rule 230. Rules are associated with files created or modified in smart shares, such as smart share 210. In one example this association is based on the file name extension of the file. For example, a file name extension of “JPG” typically indicates that the file contains a digital image in Joint Photographic Experts Group (“JPEG”) format and may thus be associated with rules for JPEG digital image files. In another example, metadata, such as EXIF metadata common to digital photographs, may be used to establish an association between a file and a rule. Other information contained in or associated with a file may also be used to establish a relationship between the file and one or more rules. An association may also be based, at least partially, on the event type—whether a file was just created or modified or some other interesting file event just took place as indicated by the event.

Rules, such as rule 230, may be implemented in a variety of forms. In one example a rule is implemented as a script, such as a batch file, a Visual Basic (“VB”) Script or JavaScript or some other runtime-interpreted script. In another example a rule may be implemented as an executable software module or program. Further, some rules may be provided with SSS 110 when it is installed and others may be provided and/or customized by a user. Finally, a rule may make use of any file information or event information provided by SSS 110, as well as any other accessible data from any other source. While it should be understood that the foregoing examples are not intended as limitations, for simplicity of discussion the term “rule” includes the examples provided above as well as any other suitable mechanisms for specifying the processing of a file. Further, a rule may be implemented separate from SSP 220 and/or SSS 110, or as an integral part of SSP 220 and/or of SSS 110.

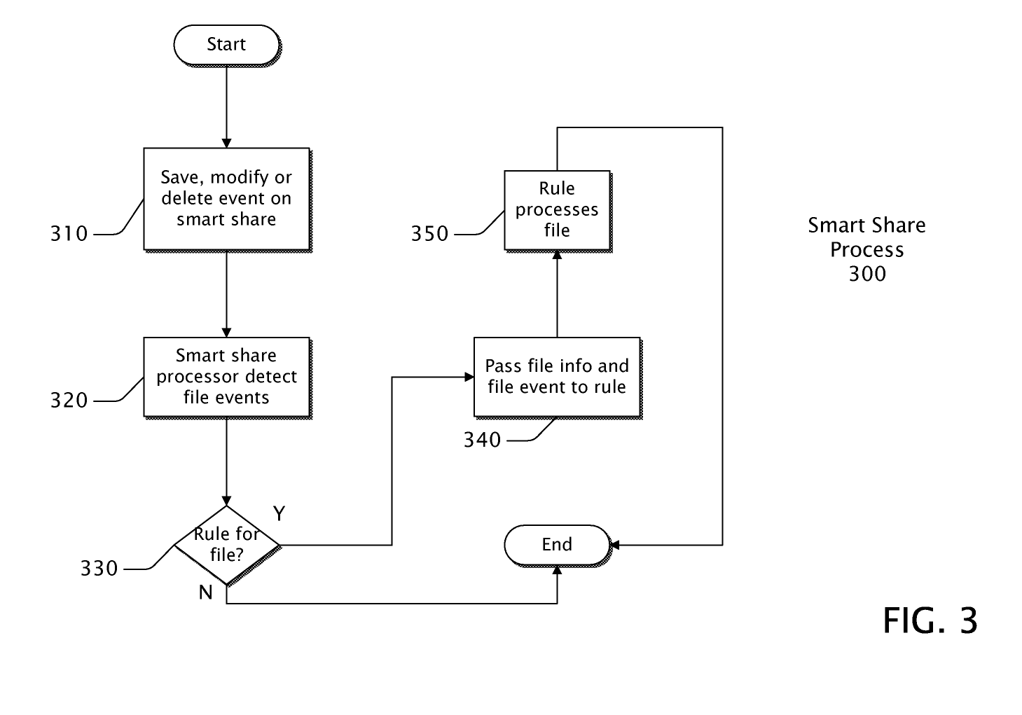

FIG. 3 is a block diagram showing the basic process 300 used by smart share processor 220 to process events, such as creation and modification events related to files in associated smart shares. Process 300 automates for a user what would otherwise be a time-consuming and complex manual process—the user simply copies files into smart share 210, or modifies them, and process 300 automates all further processing of the files based on the rules. Alternatively, another device (rather than a user) could perform the file creation or modification in smart share 210. Following is a description of the general processes 300.

Block 310 indicates an event generated resulting from the occurrence of an interesting file event, such as the creation or modification (including deletion) of a file, on an associated smart share, such as smart share 210.

Block 320 indicates SSP 220 detecting the event generated in block 310.

Block 330 indicates SSP 220 determining if there are one or more rules associated with the file responsible for the event. If there are no applicable rules, then process 300 ends. If there is an applicable rule, then SSP 220 initiates the rule and provides information about the file as well as the event type to the rule. In one example file information may include the file name, type, location, creation date, etc. File information may also include any metadata associated with the file.

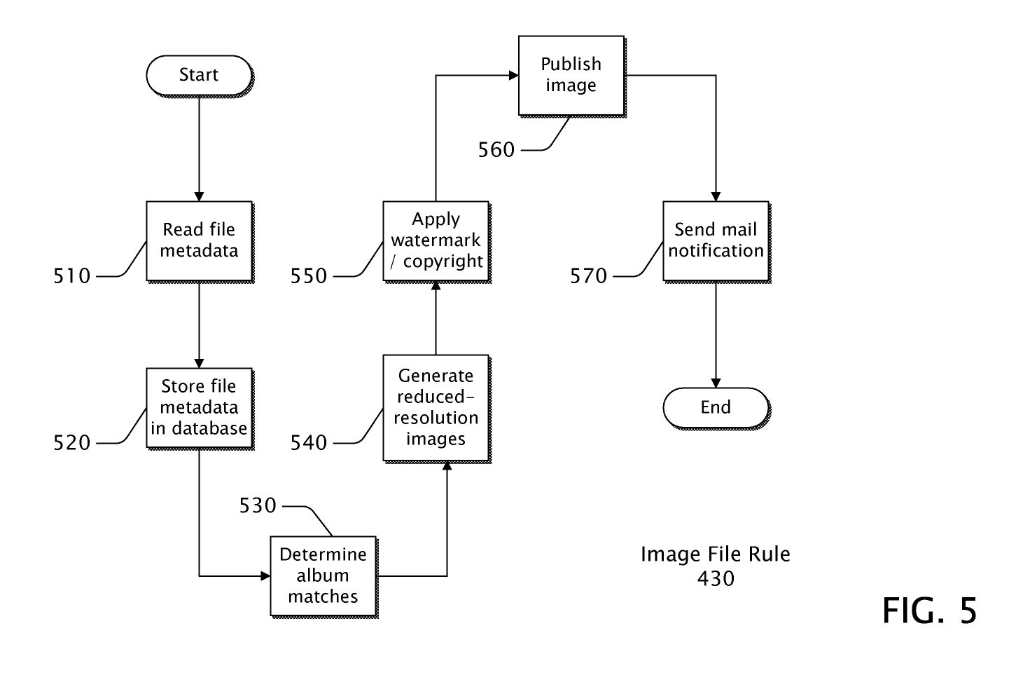

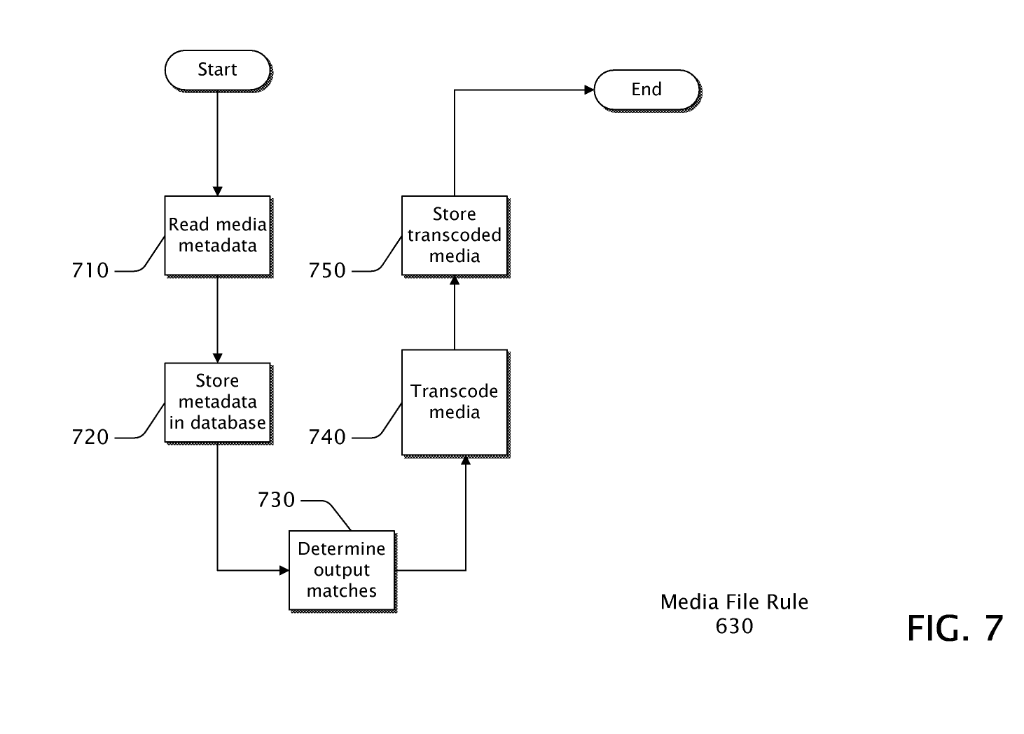

Block 350 indicates the rule processing the file. A rule may process a file in any manner desirable by the creator of the rule. Examples of rules are provided below in connection with FIGS. 5 and 7. Once all applicable rules have completed processing the file, process 300 ends.

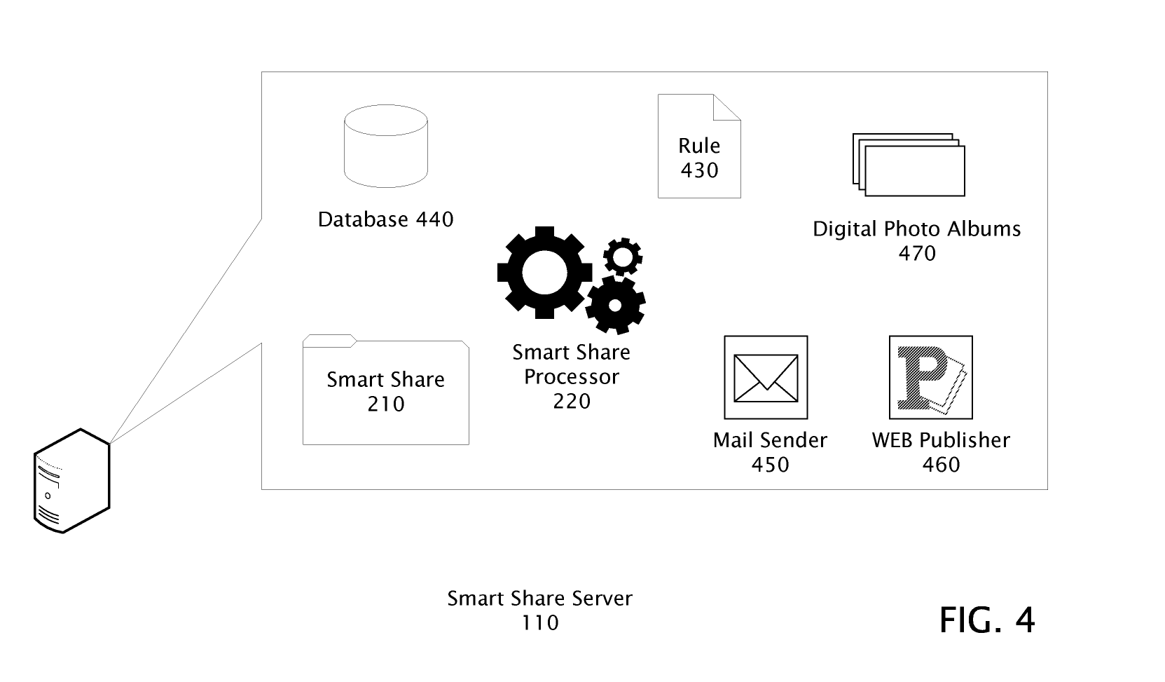

FIG. 4 is a block diagram showing an example smart share server 110 configured to process digital image files. Such digital image files may include still images, such as graphics in Portable Network Graphics (“PNG”) format or Bitmap (“BMP”) format or the like, page images such as Tagged Image File Format (“TIFF”) images or the like, or digital photographs in JPG format or the like, or video such as that provided by a digital video camera, etc., in MPEG2 format or the like. Other types of digital image files may also be processed limited only by the ability of a rule to recognize and manipulate the file and its content.

Smart share 210 and SSP 220 are similar to those described above in connection with FIG. 2. Rule 430 is a rule similar to rule 230 in FIG. 2, but specifically configured for processing digital image files. An example of rule 430 is described in detail in connection with FIG. 5. Database (“DB”) 440 is a database used in one example for storing file information, metadata, and other data, and typically operates to improve overall system performance by coalescing data into one location. DB 440 may operate on SSS 110 or it may operate on another device being coupled to SSS 110. DB 440 is an optional element and may not be present at all.

Digital photo albums 470 represent software that allows for digital images to be organized and presented to users for convenient viewing and/or download, typically via a user interface with “pages” that resembles a traditional photo album. Generally users do not need any special skills to use such a digital photo album.

Each digital photo album is further configured with a set of properties. These properties may be pre-configured during installation of SSS 110, or they may be added or modified by the user after installation. In one example, each album's properties include the following information:
Keywords used in matching digital images to the album.
An indication as to whether the album and its contents should be published to the WEB.
An indication as to whether access to the album and its contents should be limited to specific groups and/or individuals.
An indication as to whether specific groups and/or individuals should receive an email notification when the content of the album changes.
An indication as to whether a water mark or copyright notice should be applied to images in the album.
An indication as to what resolution images should be available via the album.
And indication as to whether the original-resolution image should be available for download.

In addition to these properties, each album typically displays a reduced-resolution thumbnail version of the images in the album. A thumbnail is a miniature version of the original image that is generally used for quick browsing through multiple images on a page, such as the page of an album. When a thumbnail is selected (clicked) a larger web-resolution version of the image is typically displayed for viewing. This web-resolution image is typically also a reduced-resolution version of the original image, compressed using and encoding for efficient transfer over the Internet, though much larger and of higher quality than the thumbnail. Further, the album may also make available the original-resolution image for viewing or download.

WEB Publisher (“Pub”) 460 represents a means for publishing digital photo albums 470 on the Internet, such as Internet Information Server (“IIS”) or the like, and may include an account system requiring logon so as to optionally limit access to various albums to authorized users such as friends or family of the user publishing the images. Pub 460 may operate on SSS 110 or it may operate on another device being coupled to SSS 110. Pub 460 is an optional element and may not be present at all.

Mail sender (“Sender”) 450 represents a means for sending Internet mail, such as Exchange Server (“Exchange”) or the like. Sender may operate on SSS 110 or it may operate on another device coupled to SSS 110. Sender 450 is an optional component and may not be present at all.

FIG. 5 is a block diagram showing an example rule 430 for processing digital image files. Rule 430 automates for a user what would otherwise be a time-consuming and complex manual process—the user simply copies files into smart share 210, or modifies them while stored on smart share 210, and rule 430 in conjunction with process 300 automates all further processing of the digital image files. Alternatively, another device (rather than a user) could perform the file creation or modification in smart share 210.

Prior to copying digital image files into a smart share, a user typically edits the file's metadata to add keywords or the like to identify and organize the pictures. Adding keyword metadata may be referred to as “tagging”. This may be done using the Windows Explorer file properties summary page, for example, that come with the Microsoft Windows operating system or using a software application such as the Microsoft Digital Image Suite or the like.

In one scenario, the user might take some pictures while on vacation and add the keyword “Vacation” to those images. The user might also take some pictures while at Disneyland and add the keyword “Disneyland” to those pictures. Further, the user might also add the keyword “Kids” to the pictures from both sets that include the user's children. Thus there are some pictures tagged with the keyword “Vacation”, some tagged as “Disneyland”, and some from both sets also tagged as “Kids”. Once the user saves these tagged image files into smart share 210, the images are automatically processed and published without any further user intervention per example rule 430. Following is a description of example digital image file processing rule 430.

Block 510 indicates the reading of the file metadata, including the added keywords.

Block 520 indicates storing the file metadata in DB 440 along with other file information, such as the file name, location and other properties.

Block 530 indicates the rule making use of file metadata and information, such as the keywords, to determine which digital photo albums 470 the pictures will be assigned to. In one example, this is done by matching digital image keywords to an album's keyword properties. Given a match, versions of the image are assigned to the album as described below in connection with blocks 540, 550 and 560. Considering the scenario described above, given with a keyword property of “Vacation”, another of “Disneyland”, and a third of “Kids”, the images with the matching metadata keywords will be automatically assigned to the album with the matching keyword properties. Thus the Kids album will include all the Vacation and Disneyland pictures that also include the “Kids” keyword metadata, with those same pictures being included in the matching Vacation and Disneyland albums.

Block 540 indicates reduce-resolution images being created for the album. Album properties typically define appropriate resolutions for each album, such as indicating a thumbnail and a web-resolution version of the original image. These reduced-resolution images may be created using a typical transcoding mechanism capable of recoding the image from the original format into a reduced-resolution format. In one example, an original TIFF format image may be transcoded into a reduced-resolution JPG format image, resulting in a JPG version of the original TIFF image. Further, the image height and width may be changed in the reduced-resolution version to create a thumbnail version and/or a web-resolution version of the original image. Typically, any reduced-resolution images are also stored in DB 440 along with the other file information, and/or in other folders designate to contain thumbnails and/or other reduced-resolution images.

Block 550 indicates applying a water mark and/or copyright to the various versions of the image. In some cases it may be desirable to so mark digital images before they are made available to the public via publication. This operation is optional and may not be performed for all images or even for any images. This operation may also be determined by the album properties of the album(s) the images are assigned to.

Block 560 indicates publication of the appropriate versions of the images in their assigned albums such that the album and images can be viewed over the Internet and/or some other network. Publishing may include limiting access to groups and/or individuals authorized to access a particular album, album page, and/or image. These access limitations may also be designated in album properties.

Block 570 indicates sending an email notification to groups and/or individuals notifying them an album and/or images have been updated.

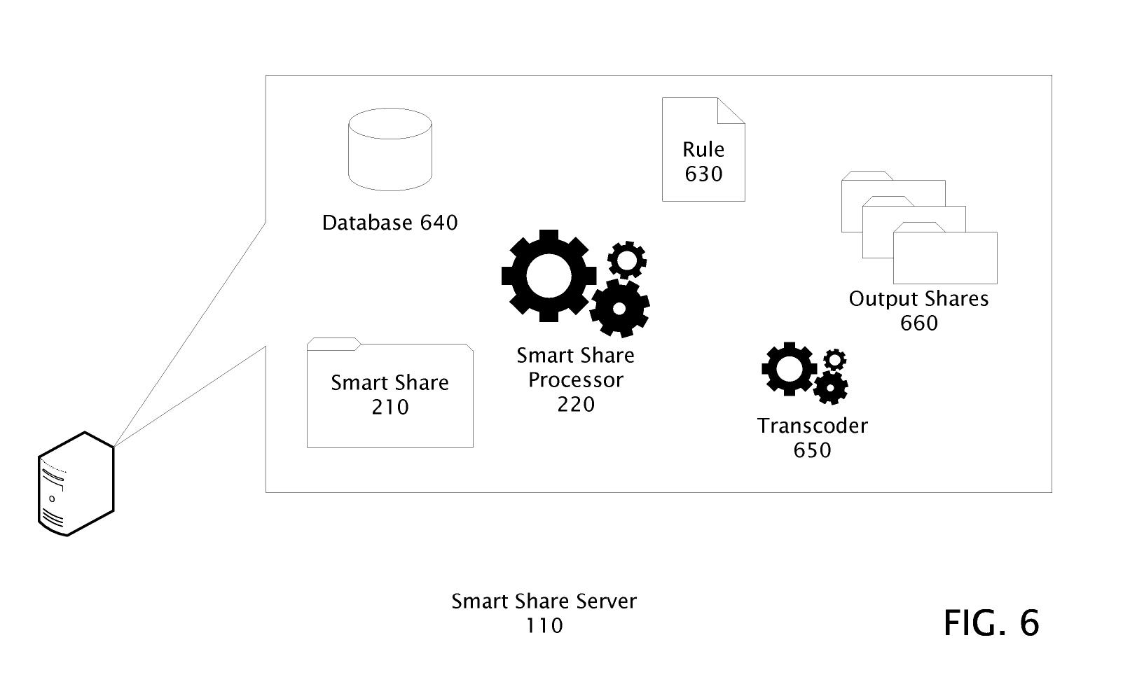

FIG. 6 is a block diagram showing an example smart share server 110 configured to process digital media files. Such digital media files may include digitally captured TV in MPEG2 or MPEG4 format or the like, or may be provided by DVRs or PVRs. Other types of digital media files, including digital audio files, may also be processed limited only by the ability of a rule to recognize and manipulate the file and its content.

Smart share 210 and SSP 220 are similar to those described above in connection with FIG. 2. DB 640 is similar to that described in connection with FIG. 4. Rule 430 is a rule similar to rule 230 in FIG. 2, but specifically configured for processing digital image files. An example of rule 630 is described in detail in connection with FIG. 7.

Transcoder 650 represents one or more mechanisms for transcoding (decoding and then recoding) digital media files from their initial format to a different format. For example, one transcoder may decode a digital media file containing video and/or audio in MPEG2 format and then recode it in another format such as H.264, Motion JPEG (“MJPEG”), Windows Media Video (“WMV”), Audio-Video Interleave (“AVI”), or the like, depending on the file content, the desired degree of compression required, the desired level of output quality, etc. Other formats may also be supported. Multiple transcoders 650 may be used to support various digital media input formats and various desired output formats. Typically output formats are selected to support devices the transcoded media files will be used with, such as MPEG Layer 3 (“MP3”) players, portable video players, software media players, and the like. Output formats may also be selected to minimize storage space requirements to store the transcoded digital media files, particularly where the initial format would require significant storage space as with MPEG2 video files.

Output shares 660 represent one or more shares created and designated to hold transcoded digital media files. An output share is generally designated to store a particular type of media file. One share, for example, may be designated to hold MP3 files, another to hold AVI files, another MPEG4 files, etc. Output shares 660 may be available to users of the computing system shares 660 are hosted on, or shares 660 may be available to any device with network or other connectivity to shares 660. By organizing transcoded digital media files in output shares 660, users of the transcoded files may easily locate digital media files in the format desired.

FIG. 7 is a block diagram showing an example rule 630 for processing digital media files. Rule 630 automates for a user what would otherwise be a time-consuming and complex manual process—the user simply copies files into smart share 210, or modifies them while stored on smart share 210, and rule 630 in conjunction with process 300 automates all further processing of the digital media files. Alternatively, another device (rather than a user) could perform the file creation or modification in smart share 210.

Prior to copying digital media files into a smart share, a user may create or edit metadata about the files. Such metadata may be stored in the file itself, or separate from the file. Such metadata may include keywords or the like to identify and organize the media. Adding keyword metadata may be referred to as “tagging”. This may be done using the Windows Explorer file properties summary page, for example, included with the Microsoft Windows operating system or using a software application intended to create and edit metadata, or the like.

In one scenario, the user might wish to maintain a library of audio and video files compatible with various media playing devices, including an MP3 player and a software media player. The user may import audio from a compact disk (“CD”) to smart share 210 such that it is automatically converted to MP3 format and stored in an MP3 output share for later download to an MP3 player. Similarly, the user may store digitized TV programs in smart share 210 to have them automatically transcoded to WMV format, for example, and stored on a WMV output share for later use with a software media player, after which the original digitized TV file may be deleted to save disk space, retaining only the smaller WMV file.

Once the user saves tagged digital media files into smart share 210, the media are automatically processed and stored in output shares 660 without any further user intervention per example rule 630. Following is a description of example digital image file processing rule 630.

Block 710 indicates the reading of the digital media file metadata, including the added keywords.

Block 720 indicates storing the file metadata in DB 640 along with other file information, such as the file name, location and other properties.

Block 730 indicates the rule making use of file metadata and information, such as the file type and/or keywords, to determine which output share 660 the transcoded media will be stored in. In one example, rule 630 designates that MPEG2 files are transcoded to WMV files and stored in a WMV output share.

Block 740 indicates transcoding the media file in smart share 210 to the output format or formats designated by rule 630. In one example, an original MPEG2 format video may be transcoded into a WMV format video, resulting in a WMV version of the original MPEG2 video file.

Block 7500 indicates storing the transcoded versions of the media in the designated output shares 660.

FIG. 8 is a block diagram showing an example computing environment 800 in which the technology described herein may be implemented. A suitable computing environment may be implemented with numerous general purpose or special purpose systems. Examples of well known systems may include, but are not limited to, personal computers (“PC”), hand-held or laptop devices, microprocessor-based systems, multiprocessor systems, servers, workstations, consumer electronic devices, set-top boxes, and the like.

Computing environment 800 generally includes a general-purpose computing system in the form of a computing device 801 coupled to various peripheral devices 802, 803, 804 and the like. System 800 may couple to various input devices 803, including keyboards and pointing devices, such as a mouse or trackball, via one or more I/O interfaces 812. The components of computing device 801 may include one or more processors (including central processing units (“CPU”), graphics processing units (“GPU”), microprocessors (“uP”), and the like) 807, system memory 809, and a system bus 808 that typically couples the various components. Processor 807 typically processes or executes various computer-executable instructions to control the operation of computing device 801 and to communicate with other electronic and/or computing devices, systems or environment (not shown) via various communications connections such as a network connection 814 or the like. System bus 808 represents any number of several types of bus structures, including a memory bus or memory controller, a peripheral bus, a serial bus, an accelerated graphics port, a processor or local bus using any of a variety of bus architectures, and the like.

System memory 809 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 809 typically stores data, computer-executable instructions and/or program modules comprising computer-executable instructions that are immediately accessible to and/or presently operated on by one or more of the processors 807.

Mass storage devices 804 and 810 may be coupled to computing device 801 or incorporated into computing device 801 via coupling to the system bus. Such mass storage devices 804 and 810 may include a magnetic disk drive which reads from and/or writes to a removable, non-volatile magnetic disk (e.g., a “floppy disk”) 805, and/or an optical disk drive that reads from and/or writes to a non-volatile optical disk such as a CD ROM, DVD ROM 806. Alternatively, a mass storage device, such as hard disk 810, may include non-removable storage medium. Other mass storage devices may include memory cards, memory sticks, tape storage devices, and the like.

Any number of computer programs, files, data structures, and the like may be stored on the hard disk 810, other storage devices 804, 805, 806 and system memory 809 (typically limited by available space) including, by way of example, operating systems, application programs, data files, directory structures, and computer-executable instructions.

Output devices, such as display device 802, may be coupled to the computing device 801 via an interface, such as a video adapter 811. Other types of output devices may include printers, audio outputs, tactile devices or other sensory output mechanisms, or the like. Output devices may enable computing device 801 to interact with human operators or other machines or systems. A user may interface with computing environment 800 via any number of different input devices 803 such as a keyboard, mouse, joystick, game pad, data port, and the like. These and other input devices may be coupled to processor 807 via input/output interfaces 812 which may be coupled to system bus 808, and may be coupled by other interfaces and bus structures, such as a parallel port, game port, universal serial bus (“USB”), fire wire, infrared port, and the like.

Computing device 801 may operate in a networked environment via communications connections to one or more remote computing devices through one or more local area networks (“LAN”), wide area networks (“WAN”), storage area networks (“SAN”), the Internet, radio links, optical links and the like. Computing device 801 may be coupled to a network via network adapter 813 or the like, or, alternatively, via a modem, digital subscriber line (“DSL”) link, integrated services digital network (“ISDN”) link, Internet link, wireless link, or the like.

Communications connection 814, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code or data maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, communications media, and the like.

1. A computing system comprising:
a smart share;
a smart share processor coupled to the smart share;
a rule accessible to the smart share processor; and
wherein a file being added to or modified on the smart share results in an event, the event being detected by the smart share processor that determines if the rule applies to the file and, if so, causes the rule to be applied.

2. The computing system of claim 1 wherein the smart share is coupled to a server.

3. The computing system of claim 2 wherein the file is added to or modified on the smart share by a device coupled to the server.

4. The computing system of claim 2 wherein the smart share processor is operational on the server.

5. The computing system of claim 1 wherein the rule is a plurality of rules and the smart share processor determines if any of the plurality of rules apply to the new file and, if so, causes the applicable rules to be applied.

6. The computing system of claim 1 further comprising:
a means for reading metadata of the file;
one or more digital albums, each digital album including a set of properties;
a means for generating a reduced-resolution image from the file;
a means for selecting a digital album from the one or more digital albums using the metadata;
a means for publishing the reduced-resolution image such that the reduced-resolution image can be accessed through the digital album via a browser or a media player;

7. The computing system of claim 1 further comprising:
one or more output shares, each output share being associated with one of a plurality of alternate media formats;
a means for transcoding a digital media contained in the file into a selected one of the plurality of alternate media formats and saving the transcoded digital media in a second file;
a means for storing the second file in the output share associated with the selected one of the plurality of alternate media formats.

8. A method comprising:
saving or modifying a file on a smart share wherein an event is generated;
detecting the event;
determining if a rule is applicable to the file;
providing a description of the event and file information for the file to an applicable rule; and
applying the applicable rule.

9. The method of claim 8 wherein the smart share is coupled to a server.

10. The method of claim 8 wherein the determining is based at least in part on a name of the file, or a portion of the name of the file, or information within the file.

11. The method of claim 8 wherein the file is one of a digital media file, a digital image file, a digital video file, and a digital audio file.

12. The method of claim 8 wherein the method is embodied on computer-readable media.

13. The method of claim 8 wherein the applying the applicable rule comprises:
reading metadata of the file wherein the file contains a digital image or a digital video;
storing at least a portion of the metadata in a database;
generating a reduced-resolution image from the file;
selecting, using the metadata, a digital album through which to publish the reduced-resolution image;
publishing the reduced-resolution image via the digital album such that the reduced-resolution image can be accessed via a browser or a media player.

14. The method of claim 13 further comprising applying a watermark or copyright to the reduced-resolution image.

15. The method of claim 13 further comprising sending an email notification indicating the publishing.

16. The method of claim 13 wherein the method is embodied on computer-readable media.

17. The method of claim 8 wherein the applying the applicable rule comprises:
reading metadata of the file wherein the file contains digital media;
storing at least a portion of the metadata in a database;
transcoding the digital media into an alternate media format and saving the transcoded digital media in a second file;
selecting, using the metadata, an output share into which to store the second file;
storing the second file in the output share.

18. The method of claim 17 wherein the applying the applicable rule further comprises publishing the second file such that the second file can be accessed via a browser or a media player.

19. The method of claim 18 wherein the applying the applicable rule further comprises sending an email notification indicating the publishing.

20. The method of claim 17 wherein the method is embodied on computer-readable media.
